(19) United States
(12) Patent Application Publication
(10) Pub. No.: US 2014/0264131 A1
(43) Pub. Date: Sep. 18, 2014

(54) Fluid Flow Valve

(71) Applicant: CARTEN CONTROLS INC., Cheshire, CT (US)

(72) Inventors: Paul A. Katz, West Simsbury, CT (US); Paul Hoynack, Killingsworth, CT (US); Brian Cadarr, Torrington, CT (US); Ronald J. Casavant, Torrington, CT (US)

(73) Assignee: CARTEN CONTROLS INC., Cheshire, CT (US)

(21) Appl. No.: 13/834,795

(22) Filed: Mar. 15, 2013

(51) Int. Cl. F16K 1/34

(52) U.S. Cl. CPC F16K 1/34
USPC 251/333

(57) ABSTRACT

A fluid flow valve, the fluid flow valve having a body comprising a body inlet, a body outlet, and a housing; a movable member positioned within the housing and having a lower face, the movable member being movable between a position spaced from a position in said body when said valve is in an open position and movable to a sealing position when said valve is in a closed position; an elongated channel between the body inlet and the body outlet, wherein the channel has at least an essentially uniform internal diameter, with the exception of a raised seat therein, from the body inlet to the body outlet, and a raised seat positioned within the channel, wherein the lower face of the movable member is in the sealing position when positioned against the raised seat and a lip formed in the body.

### BACKGROUND OF THE INVENTION

1. Field of the Invention

The present invention relates to valves generally and, more particularly, but not by way of limitation, to a novel bellows fluid flow valve which is particularly useful in applications in which maintaining the purity of the fluid passing through the valve is critical.

2. Background Art

Fluid flow valves are widely used in a variety of applications for controlling the flow of fluids. In some applications, it is critical that the purity of the fluid passing through the valve be maintained. An example of such an application is in the handling of gas in the manufacture of semiconductors.

Known conventional valves for such applications as the latter mentioned above suffer from the disadvantage that the configuration thereof permits impurities to enter the gases passing through them. For example, such conventional valves typically employ, as a valve body, a two piece design. This two piece design allows impurities to collect and enter the fluid passing through them. Such conventional valves also typically employ, as a sealing member, a relatively large disk or plug constructed of a synthetic material, such as PCTFE (Polychlorotetrafluoroethylene). This relatively large volume of synthetic material absorbs moisture which can enter the fluid as an impurity. Other impurities, such as other gases, may be similarly absorbed. Furthermore, the sealing disks or plugs of such valves are attached by means of bolts having heads which project into the flow path, disrupting the flow and/or leading to contaminant particle generation. Also such valves frequently have other such projections or sharp edges which also lend themselves to contaminant particle generation.

A further disadvantage of some known conventional valves is that, when they are moved to a closed position, there is wiping action between sealing members, which wiping action is provided to wipe debris from the faces of the sealing members. This feature, of course, will loosen contaminant particulate matter into the fluid passing through the valves.

One example of a state of the art fluid flow valve is described in U.S. Pat. No. 5,385,334. While this construction has served its owners well, it is believed that still further developments and advances in the art are both desirable and achievable.

For example, the commercial valve described in the '334 patent has an inlet and outlet diameter of approximately 4 inches, which may be enlarged slightly using adaptors up to diameters of about 6 inches. Testing and commercial usage of such a valve has seen typical values of Cv of approximately 1,000.

It would be desirable to develop a fluid flow valve that has all of the advantages of the aforementioned fluid flow valve along with a Cv greater than 1,000. At first glance, one skilled in the art might think that simply enlarging the valve in the '334 patent will achieve the desired Cv.

However, such a skilled artisan would be disappointed for at least the following reasons, namely insufficiently achievable flow coefficients (Cv) of the design, impurity contribution levels, weight and size of the valve. For example, it has been experimentally determined that simply increasing the diameter of the inlet and outlet pipe ends does not guarantee an increase in the Cv. Similarly, simply increasing the diameter of the seat size does not achieve the desired result. Moreover, even if it were true that simply increasing the size of the valve body would provide for an improved Cv, such increase in size, using the materials described or suggested in the prior art for the valve body, would result in a valve body that would weigh too much for practical and/or commercial usage. That is, current designs, such as those made pursuant to the '334 patent, which utilize bar stock bodies, would become too large in both size and weight. Simply put, large valves using state of the art bar stock bodies would be difficult if not impossible to use in the semiconductor industry, as but just one example. Moreover, simply increasing the size of the current fluid flow valve body would also result in the following undesirables such as, just to name a few, the need to increase the thickness of the body, the need to significantly increase the length of the movable parts as defined herein, a need to significantly change the bearing technology and the bellows design, and the need to significantly change the bonnet design, as well as modifying the seals used therein. Simply put, larger does not mean better, and for sure, larger does not translate into better, as would be understood by those skilled in the art.

Thus, it is desirable to provide an improved fluid flow valve that overcomes the perceived disadvantages above and achieves the advantages and objectives set forth herein.

### SUMMARY AND OBJECTIVES OF THE INVENTION

Accordingly, it is a principal object of the present invention to provide a fluid flow valve in which the volume of the sealing member is minimized.

It is a principal object of the present invention to provide a fluid flow valve that is constructed from a one piece cast body to allow for the possibility of manufacturing a larger magnitude valve of manageable size and weight.

Another principal object of the present invention to provide a fluid flow valve that utilizes inlet and outlet sizes exceeding 6 inch tube ends with a seat size exceeding 6 inches.

Yet another principal object of the present invention to provide a fluid flow valve that incorporates a close to open travel of essentially 9″, which allows the seat holder to be completely removed from the flow path. Where current valve designs incorporate an open to close travel of about 5.5″, it has been found that an increase of about 3.5″ of travel, when compared to current designs, requires significant changes to the valve design. However, with such new and non-obvious modifications in combination with the increase closed to open travel distance, unexpected and advantageous values of the flow coefficient (Cv) can be achieved.

It is a further object of the invention to provide a fluid flow valve in which there are no projections or sharp edges that can lead to contaminant particle generation, nor is there any welding that is required in manufacturing of the preferable one piece high purity stainless steel cast body.

It is a further object of the invention to provide a fluid flow valve that includes optional upstream and downstream purge ports and or purge valves.

It is an additional object of the invention to provide a fluid flow valve which does not provide wiping action between sealing members when the valve is being opened or closed.

It is another object of the invention to provide a fluid flow valve which is of such improved construction that it can be made smaller than conventional valves while providing an increased Cv and other advantages as set forth herein.

Accordingly, it is a principal object of the present invention to provide a fluid flow valve in which the flow coefficient (Cv) or fluid flow through the valve is increased.

Other objects of the present invention, as well as particular features, elements and advantages thereof, will be elucidated in, or be apparent from, the following description and the accompanying drawing figures.

Therefore, and generally speaking, in accordance with a first preferred embodiment, the invention is directed to a fluid flow valve comprising a body comprising a body inlet, a body outlet, a housing; a movable member positioned within the housing and having a lower face, the movable member being movable between a position spaced from a position in said body when said valve is in an open position and movable to a sealing position when said valve is in a closed position; an elongated channel between the body inlet and the body outlet, wherein the channel has at least an essentially uniform internal diameter, with the exception of a raised seat therein, from the body inlet to the body outlet, and a raised seat positioned within the channel, wherein the lower face of the movable member is in the sealing position when positioned against the raised seat and a lip formed in the body.

In specifically preferred embodiments, the body of the fluid flow valve is a one piece cast body. In a specific embodiment thereof, the one piece cast body is made from 316 L. In other specific embodiments, the diameters of the body inlet and body outlet are the same, and their respective diameters are at least essentially 8″. Advantageously, the preferred embodiments herein provide achieve a Cv between 1000 and 2383. Preferably, the fluid flow valve of the preferred embodiments is of the bellows type.

### BRIEF DESCRIPTION OF THE DRAWINGS

The above set forth and other features of the invention are made more apparent in the ensuing Description of the Preferred Embodiments when read in conjunction with the attached Drawings, wherein:

FIG. 1 is an isometric view of a fluid flow valve constructed according to the present invention;

FIG. 2 is a side view, partially in cross-section, of the valve of FIG. 1 with purge valves included and in an open position;

FIG. 3 is a fragmentary, enlarged detail of a portion of FIG. 2; and

FIG. 4 is a side view, partially in cross section, of the valve of FIG. 1 in a sealing position.

Identical reference numerals in the figures are intended to indicate like parts, although not every feature in every figure may be called out with a reference numeral,

### DETAILED DESCRIPTION OF THE PREFERRED EMBODIMENTS

Reference should now be made to the drawing figures, on which similar or identical elements are given consistent identifying numerals throughout the various figures thereof, and on which parenthetical references to figure numbers direct the reader to the view(s) on which the element(s) being described is (are) best seen, although the element(s) may be seen also on other views. It is also noted that the subject matter of U.S. Pat. No. 5,385,334 is incorporated herein by reference in its entirety.

Generally speaking, the figures in greater detail show, and the following text discloses, a fluid flow valve that comprises a body comprising a body inlet, a body outlet, a housing; a movable member positioned within the housing and having a lower face, the movable member being movable between a position spaced from a position in said body when said valve is in an open position and movable to a sealing position when said valve is in a closed position; an elongated channel between the body inlet and the body outlet, wherein the channel has at least an essentially uniform internal diameter, with the exception of a raised seat therein, from the body inlet to the body outlet, and a raised seat positioned within the channel, wherein the lower face of the movable member is in the sealing position when positioned against the raised seat and a lip formed in the body.

In a preferred embodiment, the raised seat is positioned on a side of the channel opposite the housing and between the body inlet and body outlet, and wherein the channel has an inner surface, wherein the raised seat comprises a leading sloped side on the body inlet side of the raised seat, wherein the leading sloped side has a sloping angle and a length, and wherein the intersection of the leading sloped side and the channel inner surface is a radius. Preferably, the raised seat also comprises a trailing sloped side on the body outlet side of the raised seat, wherein the trailing sloped side has a sloping angle that mirrors the sloping angle of the leading sloped side and has a length of at least essentially the same length as the leading sloped side. Advantageously, and as discussed below, the intersection of the trailing sloped side and the channel inner surface is a radius.

In a preferred embodiment, the body is a one piece cast body, and in a specific embodiment, is made from 316 L.

In a specific preferred embodiment, the diameters of the body inlet and body outlet are the same, and their respective diameters are at least essentially 8″. Preferably, in all embodiments herein, the seat size has a diameter that is the same as the diameters of the body inlet and body outlet, and so in such a specific embodiment, the seat size is likewise at least essentially 8″. However, in additional preferred embodiments, the respective diameters of the body inlet, body outlet and seat size can be between at least essentially 4″ and 12.5″. In the specification and the claims, “essentially” and “at least essentially” are intended to mean that the sizes may not be perfectly 8″ or perfectly identically sized as those skilled in the art would understand that certain tolerances in manufacturing are anticipated and allotted for in design.

In other preferred embodiments, the present invention may include an inlet pipe adapter coupled to the body inlet and an outlet pipe adaptor coupled to the body outlet, wherein the inlet side of the inlet pipe adaptor and the outlet side of the outlet pipe adapter are the same and have a respective diameter in the range of at least essentially 4″ to 12.5.″

As discussed herein, the preferred embodiments will provide a Cv of the fluid flow valve of between 1000 and 2383. And to distinguish the present fluid flow valve from other valves, it should be clear that the present invention and all embodiments herein are directed to fluid flow valves that are known in the art as bellows type fluid flow valves.

Turning now to the figures in particular, there is illustrated a fluid flow valve, generally indicated by the reference numeral 28, constructed according to the present invention. Valve 28 includes a one piece cast body 1 in the form of generally hollow cylindrical solid, to which inlet and outlet pipe adaptors 19 and 20, respectively, may be welded. Optional upstream and down stream purge ports and purge valves 26 are welded to the one piece cast body 1. A generally hollow, cylindrical bonnet 2 is centrally axially disposed in one piece cast body 1 and is fixedly attached to one piece cast body 1 by means of a plurality of screws, as at 22, which are threaded into the one piece cast body 1. A lifting ring 27 is irremovably fixedly attached to the one piece cast body 1.

Reference should now be made to FIG. 2 alone for an understanding of the internal elements of valve 28.

An acme stem 5 having a handwheel 23 fixedly attached to its distal end by screw 25 and a thread defined 29 along its proximal end is centrally axially disposed in bonnet 2. Stem 5 is secured in bonnet 2 against radial movement with respect thereto by means of an annular upper guide bearing 16 disposed in the inner periphery of the distal end of the bonnet and an annular lower guide bearing 4 disposed in the inner periphery of the proximal end of the bonnet. Upper guide bearing 16 is secured in place by means of a retaining ring 18. An annular weather seal 17 sealing engages acme stem 5 and the distal end of bonnet 2. Disposed in a groove defined around the inner periphery of the proximal end of bonnet 2 and extending from the distal end of the bonnet is an annular acme nut 3 into which thread 29 of acme stem 5 is threaded. Acme nut 3 is fixedly attached to the distal end of bonnet 2 by means of a thread and tack welding.

The use of an acme thread, which has a flat surface on the outer periphery of the threads thereof, permits lower guide bearing 4 to bear directly against the thread. This permits shortening of the length of stem 5 over conventional valves, in that the latter typically places two radial support bearings on the unthreaded portion of the stem. The latter arrangement requires that the stem be unnecessarily long.

Disposed adjacent the proximal end of acme stem 5 is a disk shaped pusher plate 30 fixedly attached to acme stem 5 by means of welding, lying in a plane orthogonal to the major axis of bonnet 2. Disposed between pusher plate 30 and the proximal end of acme stem 5 and in contact with the later is an annular thrust washer 10, lying in a plane parallel to the plane of pusher plate 30. Disposed between thrust washer 10 and pusher plate 30 is an annular wave spring 15.

Pusher plate 30, wave spring 15 and thrust washer 10 are disposed in a generally cylindrical, central hollow portion 38 of seat holder 6, with a disk shaped thrust bearing 12 disposed between the lower surface of pusher plate 30 and the bottom of the central hollow portion 38. Washer 13 is disposed between the lower surface of pusher plate 30 and thrust bearing 12. Washer 11 is disposed between the lower surface of thrust bearing 12 and the bottom of the central hollow portion 38 of seat holder 6. Thrust washer 10, and therefore, wave spring 15 are secured in central hollow portion 38 by means of an annular retaining ring 14 disposed in a groove defined around the upper periphery of the central hollow portion 38, with a lower surface of the retaining ring bearing against the upper surface of the thrust washer 10.

Disposed about and encasing bonnet 2 is a cylindrically hollow bellows 8. The proximal end of bellows 8 is fixedly attached to the outer periphery of a rim formed as an extension of the upper surface of seat holder 6 around the periphery of central hollow portion 38 of seat holder 6. The distal end of bellows 8 is fixedly attached to a rim formed as an extension of the lower surface of the central opening of annular bellows flange 9. Bellows flange 9 is fixedly captured between bonnet 2 and the distal edge of one piece cast body 1, with a nickel foil seal 21 disposed on the lower face of the bellows flange. An annular, semi-resilient seat insert 7 is fixedly disposed in the outer periphery of a lower surface of seat holder 6, the attached means of which will be described below.

Valve 28 is shown on FIG. 2 in its 100% open position. Valve 28 is put in its dosed position by means of the clockwise rotation of handwheel 23 which causes the clockwise rotation of acme stem 5. That causes seat holder 6 and the other elements attached thereto to advance into one piece cast body 1 until seat insert 7 is in sealing engagement with one piece cast body 1, FIG. 4 shows valve 28 in the closed position. During this advancement, seat holder 6 with seat insert 7 therein is held against rotation by bellows 8 and is isolated from the rotational motion of pusher plate 30 by thrust washer 10, assuring that the seat insert engages with one piece cast body 1 without wiping motion. It is to be noted that there are no elements of seat holder 6 or other elements attached thereto in the flow path of fluid passing through the valve when the valve is in its 100% open position. Also, it is to noted that all elements of valve 28 which contact the fluid are smooth, with no projection or sharp edges thereon, thus minimizing the opportunity for the formulation of particulate contaminants. It is to be noted that due to one piece cast body 1 fewer welds are exposed to the fluid passing through, thus minimizing the opportunity for the formulation of particle contaminants.

The distance of open to close travel of valve 28 has been greatly increased when compared to previous bellows valve designs such as U.S. Pat. No. 5,385,334. The open to close travel distance of valve 28 has been increased essentially by 3.5″ when compared to previous bellows designs.

Importantly, FIG. 2 illustrates an elongated channel 24 between the body inlet 44 and the body outlet 45, wherein the channel 24 has at least an essentially uniform internal diameter preferably at least essentially 8″, but other preferred embodiments are within the range of at least essentially 4″ to at least essentially 12.5″ as the internal diameter, from the body inlet 44 to the body outlet 45. The exception to this uniform diameter is the inclusion of the aforementioned raised seat defined by leading sloping side 39 and trailing sloping side 40. As discussed herein, with the raised seat positioned within the channel 24, the lower face of the movable member is in the sealing position when positioned against the raised seat 36 and a lip 47, which itself is formed in the body at about the intersection of the housing 48 and the channel 24 at the position shown most clearly in FIGS. 2 and 4.

As illustrated, the raised seat, generally indicated at 36, is positioned on a side of the channel 24 opposite the housing, which itself is generally indicated at 48, and between the body inlet 44 and body outlet 45. As illustrated, the leading sloped side 39 is on the body inlet side (i.e. the left side, as viewed in FIG. 2 for example) of the raised seat 36, and has a sloping angle of about 45° and a length that will obvious vary according to the diameter of the channel and body inlet and outlet, but is something that is easy calculable by those skilled in the art. For example, for a channel with approximately an 8″ inner diameter, a preferred length of the leading sloped side is about 2.5″. Importantly as well, the intersection of the leading sloped side 39 and the channel inner surface 24 is a radius. This radius is illustrated with reference number 46. This rounded “corner” is very important to the functionality of the present invention, and helps provide increased laminar flow, increased flow coefficient (Cv) and minimizes the opportunity for the formulation and or build-up of particulate contaminants. For example, this feature of a radius at 46 is not found in the prior art. Closest known to the inventors is the description and illustration in U.S. Pat. No. 4,199,850, but it can be seen in this '850 patent that the corresponding intersection between the channel surface and the leading sloped side is a sharp angle, which leads to less than desirable increased turbulent flow, decrease in flow coefficient (Cv) and increased opportunity for the formation and or build-up of particle contamination.

As mentioned above with reference to radius 41, it can be seen that the trailing sloped side 40 on the body outlet side (i.e. the right side, as seen in FIG. 2) of the raised seat 36 has a sloping angle that mirrors (i.e. is the same, i.e. but in the downward direction) the sloping angle of the leading sloped side 39 and, has a length of at least essentially the same length as the leading sloped side. In essence, the raised seat of the present invention is almost like an isosceles triangle. To be sure, the intersection of the trailing sloped side and the channel inner surface is (i.e. forms) radius 41. This too is very distinct from the design illustrated in the aforementioned '850 patent, and is significantly advantageous over the performance of the '850 patent for at least the following reasons, namely increased laminar flow, increased flow coefficient (Cv) and minimizes the opportunity for the formulation and or build-up of particulate contaminants.

Reference now should be made to FIG. 3 for an understanding of the configuration of seat holder 6 and the means of attachment of seat insert 7 to the seat holder. Seat holder 6 includes an annular flange section 35 formed around the upper portion of the outer periphery of the seat holder and a flat, lower, central section 42. Flange section 35 and central section 42 are joined by a sloped intermediate section 32. It can be seen that an outwardly bulging intersection 31 between central and intermediate sections 42 and 32 is quite rounded, thus avoiding any sharp projections that could result from a different configuration.

Seat insert 7 has a generally rectangular cross-section and fits tightly into a corresponding step 34 defined in the lower outer edge of flange section 35 of seat holder 6, with the lower surface of the seat insert flush with the lower surface of the flange section. An integral rim 33 depends from the lower edge of the outer periphery of flange section 35 and lies adjacent the cylindrical outer surface of seat insert 7. After seat insert 7 is so mounted on seat holder 6, an annular tool (not shown) having a sloped inner surface is forced over the lower outer edge of seat insert 7, bending the distal end of rim 33 inward and locking the seat insert in place.

Rim 33 does not completely cover the outside of seat insert 7, but a monolithic annular flange 43 formed around the lower outer edge of seat insert 7 extends outwardly beyond the rim 33. This arrangement has two functions. First, flange 43 prevents scraping of seat holder 6 against the inner surface of one piece cast body 1 when valve 28 is assembled. Second, when valve 28 is in use, flange 43 absorbs shock waves and prevents metal-to-metal contact.

It can be seen that seat insert 7 has a small surface area, only large enough to affect sealing with the rim of point 36 in one piece cast body 1 and comprises a relatively small volume of material into which only a relatively small volume of moisture impurity or other impurities may be absorbed, in contrast to conventional valves. The width of seat insert 7 is only about four to five percent of the diameter of seat holder 6.

It is important to note that, when valve 28 is moved to its closed position (FIG. 4), the flat lower surface of seat insert 7 will engage with one piece cast body 1 without any wiping action.

As is noted above, the arrangement of having lower guide bearing 4 disposed against the thread portion of acme stem 5 permits shortening of one dimension of valve 28. A further shortening is achieved by having seat insert 7 disposed above lower portion 30 of seat holder 6.

The components of valve 28 may be fabricated of any materials suitable for the fluid(s) to be handled and seat insert 7 will, in most cases, preferably be fabricated from PCTFE (Polychlorotetrafluoroethylene).

For the reasons noted above, most notably with respect to reducing size and weight and for the other explicitly and inherent advantages set forth herein, the body is a one piece cast body, and in a preferred embodiment, is made from 316 L.

Those skilled in the art should now appreciate that the present fluid flow valve lends itself to different sizes while still achieving all the advantages noted herein. However, with the inner diameter of the body inlet 44 equaling (within acceptable manufacturing tolerances) the inner diameter of the body outlet 45 in all preferred embodiments, in a first preferred embodiment, their respective diameters are at least essentially 8″, with a seat size having a diameter that is the same as the diameters of the body inlet and body outlet. However, as will now be understood the construction of the present invention easily adapts itself to designs where the body inlet and body outlet diameters are between essentially 4″ and 12.5″, again with a seat size of the same diameter as that of the body inlet and body outlet.

Those skilled in the art will also now appreciate that adaptors 19, 20 may be used to further increase and/or decrease the fluid flow inlet and/or outlet sizes. In preferred embodiments, an inlet pipe adapter may be coupled to the body inlet and an outlet pipe adaptor may be coupled to the body outlet, wherein the inlet side of the inlet pipe adaptor and the outlet side of the outlet pipe adapter are the same and have a respective diameter in the range of 4″ to 12.5″. The diameters of the inlet pipe adapter and outlet pipe adaptor need not be the same as the diameters of the respective body inlet and body outlet to which they are coupled.

And lastly, but just as importantly, the constructions of the present invention as set forth above provide for the achieving of Cv values between 1000 and 2383 (depending on the body inlet and body outlet diameters and other variables as disclosed herein), which is to the inventors' knowledge, heretofore unachievable with valves of the types herein, and in particular, with valves of the bellows type of which are the preferred embodiments. As a specific example, for an 8″ channel diameter a Cv of between about 2000 and 2383 can be achieved.

It will thus be seen that the objects set forth above, among those elucidated in, or made apparent from, the preceding description, are efficiently attained and since certain changes may be made in the above construction without departing from the scope of the invention, it is intended that all matter contained in the above description or shown on the accompanying drawing figures shall be interpreted as illustrative only and not in a limiting sense.

It is also to be understood that the following claims are intended to cover all of the generic specific features of the invention herein described and all statements of the scope of the invention which, as a matter of language, might be said to fall therebetween.

What is claimed is:

1. A fluid flow valve, the fluid flow valve comprising:
a body comprising a body inlet, a body outlet, and a housing;
a movable member positioned within the housing and having a lower face, the movable member being movable between a position spaced from a position in said body when said valve is in an open position and movable to a sealing position when said valve is in a closed position;
an elongated channel between the body inlet and the body outlet, wherein the channel has at least an essentially uniform internal diameter, with the exception of a raised seat therein, from the body inlet to the body outlet, and
a raised seat positioned within the channel, wherein the lower face of the movable member is in the sealing position when positioned against the raised seat and a lip formed in the body.

2. The fluid flow valve as claimed in claim 1, wherein the raised seat is positioned on a side of the channel opposite the housing and between the body inlet and body outlet, and wherein the channel has an inner surface, wherein the raised seat comprises:
a leading sloped side on the body inlet side of the raised seat, wherein the leading sloped side has a sloping angle and a length, and wherein the intersection of the leading sloped side and the channel inner surface is a radius.

3. The fluid flow valve as claimed in claim 2, wherein the raised seat comprises:
a trailing sloped side on the body outlet side of the raised seat, wherein the trailing sloped side has a sloping angle that mirrors the sloping angle of the leading sloped side and has a length of at least essentially the same length as the leading sloped side.

4. The fluid flow valve as claimed in claim 3, wherein the intersection of the trailing sloped side and the channel inner surface is a radius.

5. The fluid flow valve as claimed in claim 1, wherein the body is a one piece cast body.

6. The fluid flow valve as claimed in claim 5, wherein the one piece cast body is made from 316 L.

7. The fluid flow valve as claimed in claim 1, wherein the diameters of the body inlet and body outlet are the same, and their respective diameters are at least essentially 8″.

8. The fluid flow valve as claimed in claim 7, wherein the seat size has a diameter that is the same as the diameters of the body inlet and body outlet.

9. The fluid flow valve as claimed in claim 1, wherein the body inlet and body outlet diameters are the same and their respective diameters are between essentially 4″ and essentially 12.5″.

10. The fluid flow valve as claimed in claim 9, wherein the seat size has a diameter that is the same as the diameters of the body inlet and body outlet.

11. The fluid flow valve as claimed in claim 1, comprising an inlet pipe adapter coupled to the body inlet and an outlet pipe adaptor coupled to the body outlet, wherein the inlet side of the inlet pipe adaptor and the outlet side of the outlet pipe adapter are the same and have a respective diameter in the range of 4″ to 12.5″.

11. The fluid flow valve as claimed in claim 7, comprising an inlet pipe adapter coupled to the body inlet and an outlet pipe adaptor coupled to the body outlet, wherein the inlet side of the inlet pipe adaptor and the outlet side of the outlet pipe adapter are the same and have a respective diameter in the range of 4″ to 12.5″.

12. The fluid flow valve as claimed in claim 1, wherein the Cv of the fluid flow valve is between 1000 and 2383.

13. The fluid flow valve as claimed in claim 3, wherein the Cv of the fluid flow valve is between 1000 and 2383.

14. The fluid flow valve as claimed in claim 4, wherein the Cv of the fluid flow valve is between 1000 and 2383.

15. The fluid flow valve as claimed in claim 7, wherein the Cv of the fluid flow valve is between 2000 and 2383.

16. The fluid flow valve as claimed in claim 1, wherein the fluid flow valve is of the bellows type.

17. The fluid flow valve as claimed in claim 7, wherein the fluid flow valve is of the bellows type.

18. The fluid flow valve as claimed in claim 15, wherein the fluid flow valve is of the bellows type.
